(19) United States
(12) Patent Application Publication
(10) Pub. No.: US 2008/0263248 A1
(43) Pub. Date: Oct. 23, 2008

(54) Multi-drop extension for a communication protocol

(76) Inventor: David J. Harriman, Portland, OR (US)

Correspondence Address: TROP PRUNER & HU, PC, 1616 S. VOSS ROAD, SUITE 750, HOUSTON, TX, 77057-2631, US

(21) Appl. No.: 11/788,575

(22) Filed: Apr. 20, 2007

(51) Int. Cl. G06F 12/00

(52) U.S. Cl. 710/243

(57) ABSTRACT

In one embodiment, the present invention includes an apparatus having an upstream component including a plurality of virtual bridges to control communication with a corresponding plurality of endpoint components coupled downstream of the upstream component and a shared port. The apparatus may further include a first endpoint component coupled to the upstream component via a first link and a second endpoint component coupled to the first endpoint component via a second link and to the upstream component via a third link, where the upstream component and the endpoint components are coupled in a daisy chain topology. Other embodiments are described and claimed.

### BACKGROUND

High performance serial-based interconnect or link technologies such as Peripheral Component Interconnect (PCI) Express® (PCIe®) links based on the PCI Express® Specification Base Specification version 2.0 (published March Dec. 20, 2006) (hereafter the PCIe® Specification) are being adopted in greater numbers of systems. PCIe® links are point-to-point (PTP) serial interconnects with N differential pairs intended for data transmission with either sideband clock forwarding or an embedded clock provided in each direction.

In many of today's inter-chip interconnects including PCIe® systems and others, the only permitted electrical topology uses PTP links between pairs of components. The inter-connection of multiple components is possible only by using a switch or hub. Of these links with an electrical PTP topology, the logical topology may be a bus including multiple components, as in a Universal Serial Bus (USB) or the logical topology may match the electrical topology by including only the two components on the electrical link, as in a PCIe® system. PTP links allow an improved electrical environment compared to multi-drop busses, enabling much higher performance and, potentially, lower power. However, the need for use of a switch or hub to allow the interconnection of more than two components raises costs and complexity. In many cases, the cost of this switch or hub exceeds the cost of one or more of endpoint components, and in some cases the cost of the switch may exceed the cost of a root complex. Additionally, this topology complicates circuit board routing by creating star routing topologies, in some cases with many constraints on the routing of signals.

### BRIEF DESCRIPTION OF THE DRAWINGS

FIG. 1 is a block diagram of a portion of a system in accordance with an embodiment of the present invention.

FIG. 2 is a diagram of a first message including a plurality of fields in accordance with an embodiment of the present invention.

FIG. 3 is a diagram of a second message including a variety of fields in accordance with an embodiment of the present invention.

FIG. 4 is a flow diagram of a method in accordance with an embodiment of the present invention.

### DETAILED DESCRIPTION

In various embodiments, a daisy chain topology may be used to interconnect different components, i.e., different semiconductor devices. In this way, signaling rates equal to those possible with PTP links in a similar electrical environment (length, interconnect materials, number of connectors, etc.) may be realized. Furthermore, no switch/hub components are required to support interconnection of more than two components, reducing cost. Simplified board routing of signals between components can be achieved, potentially reducing board cost.

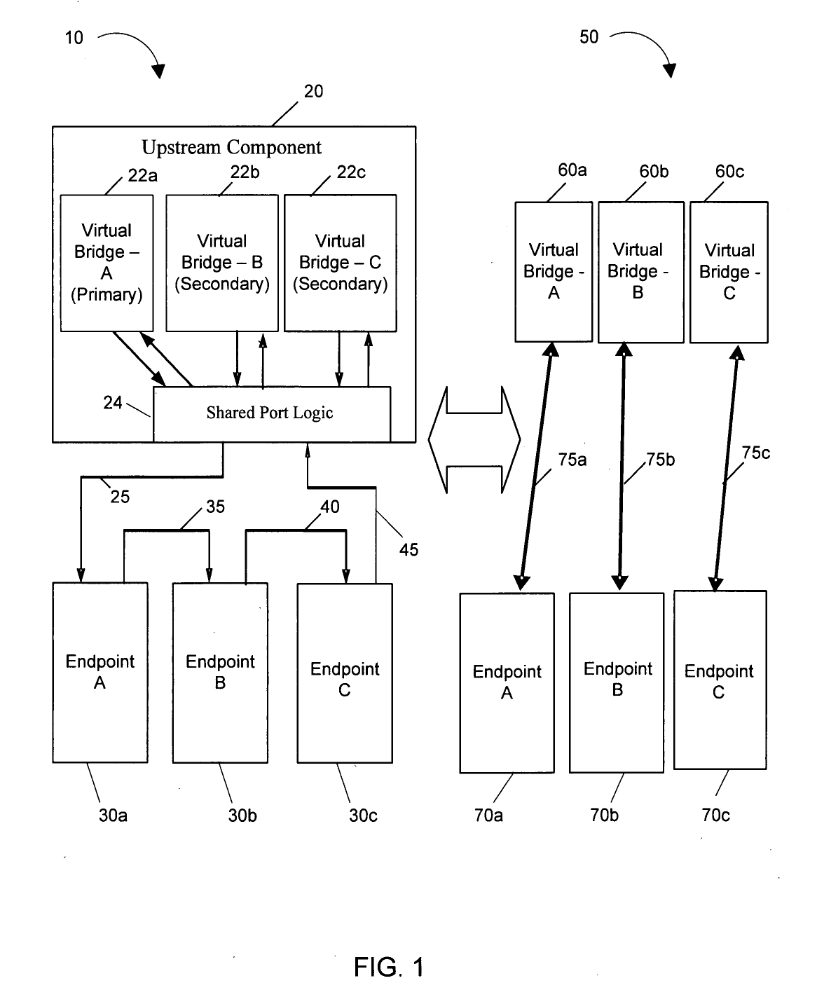

Referring now to FIG. 1, shown is a block diagram of a portion of a system in accordance with an embodiment of the present invention. As shown in FIG. 1, system 10 may include a circuit board in which semiconductor devices are coupled by board interconnections. System 10 includes an upstream component 20 that may be a root complex, switch or other such hub device. As shown in FIG. 1, upstream component 20 includes a plurality of virtual bridges 22a-22c (generically virtual bridge 22). In one embodiment, virtual bridges 22 may be virtual PCI-to-PCI bridges, although other implementations are possible. Virtual bridges 22 may be used to determine the ranges decoded and to provide a mechanism for upstream component 20 to determine which transactions target endpoints supported in the daisy chain topology. There may be one virtual bridge for each endpoint that can be supported, although it is permissible to have more virtual bridges than are needed in a particular assemblage of components (e.g., there may be three virtual bridges but only two endpoints daisy chained—in this case one of the secondary virtual bridges would appear to have no component beneath it). This mechanism allows the shared port logic to present the appearance to software (a “logical view” of a direct connection between each of the endpoints and its associated virtual bridge), establishing the concept of a “virtual port” at the upstream component for each of the daisy-chained endpoints. As further shown in FIG. 1, upstream component 20 further includes a shared port 24 that includes logic to provide for data link and physical layers of a given communication protocol such as a PCI Express® protocol. In this way, port 24 provides a virtual port mechanism to allow upstream component 20 to comprehend what information must be sent to each of the daisy-chained endpoints. This information may be translated into a link mechanism for targeting specific Transaction Layer Packets (TLPs) and Data Link Layer Packets (DLLPs).

Referring still to FIG. 1, upstream component 20 is coupled via a first link 25 to a first endpoint 30ₐ that in turn is coupled via a second link 35 to a second endpoint 30_{b}, which itself in turn is coupled via a third link 40 to a third endpoint 30_{c} that is coupled in turn via link 45 back to upstream component 20. Accordingly, a daisy chain topology is provided. Note that a logical view 50 of system 10 includes virtual bridges 60ₐ-60_{c} each coupled by links 75ₐ-75_{c} to one of endpoints 70ₐ-70_{c}.

Note that upstream component 20 can be adapted (bi-modally) to work with endpoints that do not support this daisy chaining mechanism and endpoints in accordance with an embodiment of the present invention. In this case, if a conventional endpoint were connected, the assignment messaging protocol used to establish the endpoint identifiers (described further below) would not be recognized by the endpoint, and thus upstream component 20 would determine (e.g., after a timeout) that the endpoint is a single endpoint. Similarly, endpoints in accordance with an embodiment of the present invention may be implemented such that if they do not observe the assignment messaging protocol they will assume the upstream component is conventional, and thus will act accordingly.

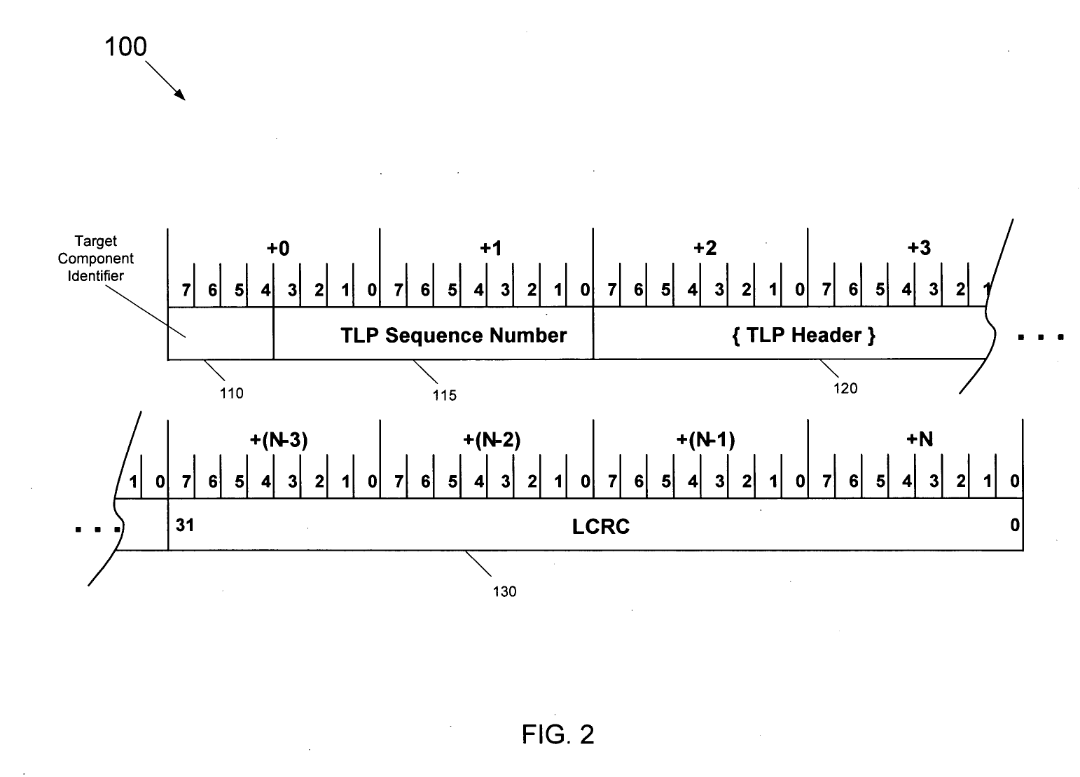

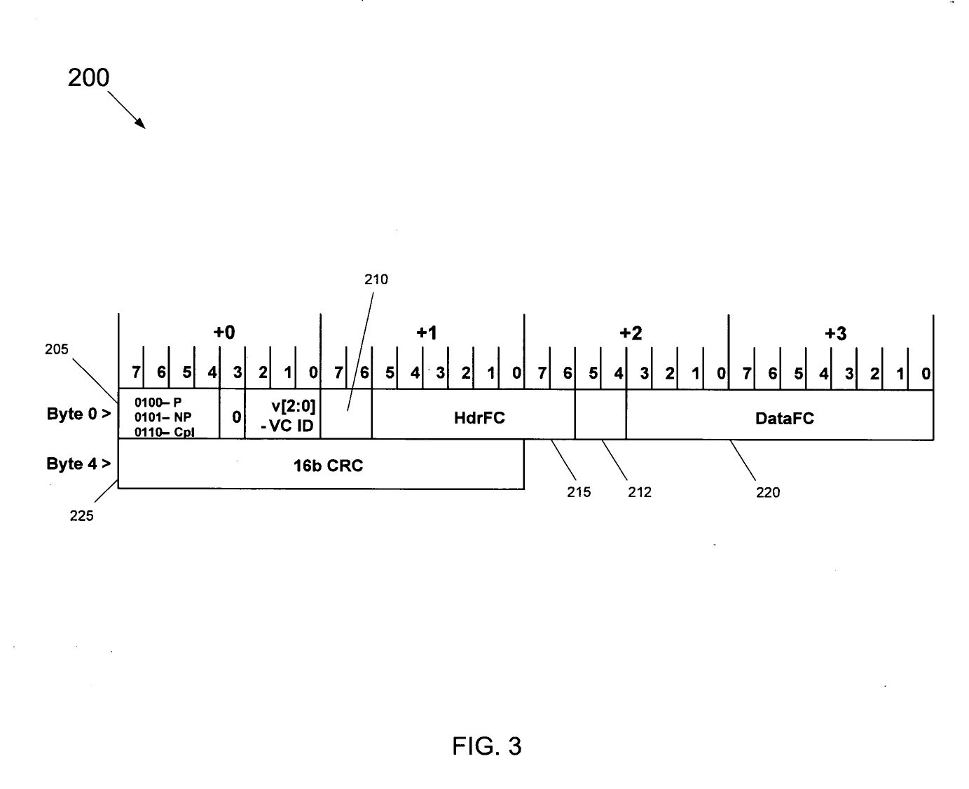

As shown in FIG. 2, a TLP message 100 includes a plurality of fields. As shown in FIG. 2, a field 110 includes a target component identifier for identifying a target component for the message, field 115 provides a TLP sequence number, field 120 provides a TLP header, and at the end of the message, a cyclic redundancy checksum (CRC) field 130 is provided. Of course other implementations are possible. Similarly, FIG. 3 shows a DLLP message 200 including various fields. Specifically, a first field 210 and a second field 212, which may correspond to reserved fields of a PCIe® protocol, may be used to indicate a target component. Of course other fields may be present in the message, including a byte 0 field 205 that includes various information such as path and virtual channel identifiers, a header field 215, a data field 220 and a CRC field 225.

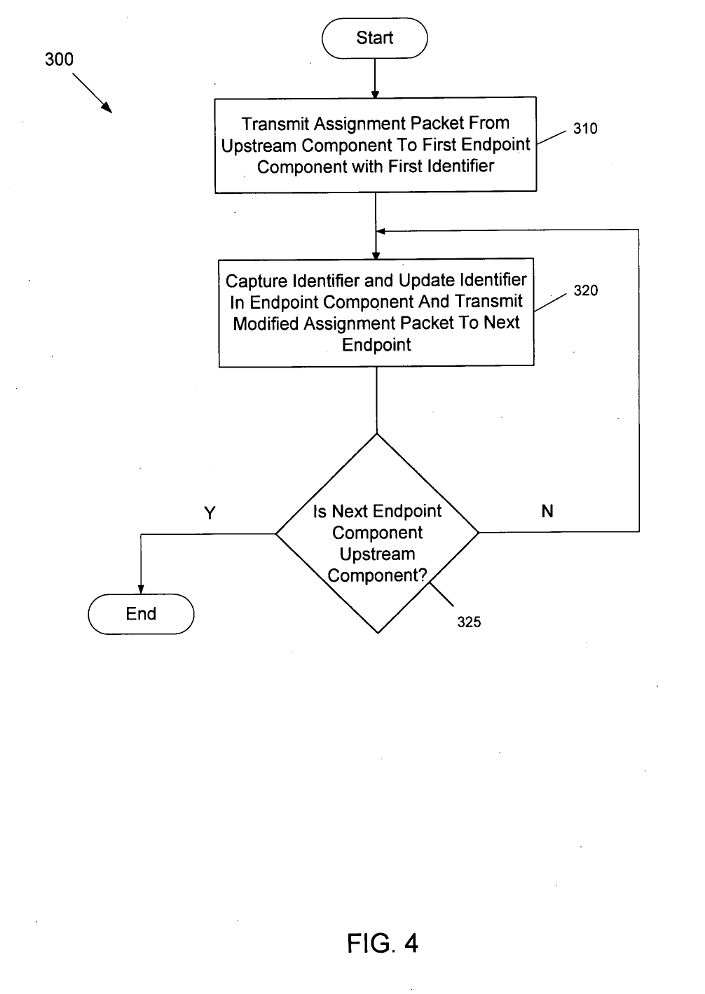

In various embodiments, identifiers which may be numbers can be assigned to each of the endpoints. In one such embodiment, an assignment process may begin by transmission of a special packet from the upstream component to the endpoint to which the upstream component is coupled in the daisy chain topology. Referring now to FIG. 4, shown is a flow diagram of a method in accordance with an embodiment of the present invention. As shown in FIG. 4, method 300 may begin by transmitting an assignment packet with a first identifier from the upstream component to the first endpoint component (block 310). The first endpoint component may capture the identifier, update the identifier (i.e., to a next number) to thus modify the assignment packet and then transmit the modified assignment packet to a next (e.g., second) endpoint component (block 320). In this way, the first endpoint component understands that its component identifier is a value of one (for example), which it may store in a destination storage. The modifying of the packet by the first endpoint may thus indicate that the first number has been assigned.

Referring still to FIG. 4, next it may be determined if the next endpoint component is the upstream component (diamond 325). If not, this process may be repeated at block 320 and diamond 325 by other endpoints coupled in turn to the first endpoint in the daisy chain topology. That is, this process may be repeated until the assignment packet reaches the last endpoint coupled between the upstream component which modifies the assignment packet again and forwards it to the upstream component The upstream component then understands that the assignment process is completed and the number of endpoints present in the daily chain topology. Thus the upstream component may determine the number of endpoint components in the daily chain based on the modified assignment packet it receives and the upstream component may store the number, e.g., and routing tables or in another such location. While shown with this particular implementation in the embodiment of FIG. 4, the scope of the present invention is not limited in this regard.

To eliminate risk of data corruption, additional routing information is added to the TLP and DLLP headers to indicate the targeted component (see FIGS. 2 and 3). While the scope of the present invention is not limited and any number of bits could be used for this targeting information, two to four bits will generally be the optimal range. One code, e.g., all 0's, is used to indicate the upstream component. The other codes are assigned uniquely to each endpoint. Alternately, one may want to distinguish TLPs/DLLPs originating from different endpoints by assigning one set of unique codes (e.g., where the most significant bit (MSB) of the targeting field is 0) to indicate packets originating from an endpoint traveling to the upstream component, and another set of unique codes (e.g., MSB of 1) to indicate packets originating the upstream component traveling to a particular endpoint. Typically all packets issued by a downstream component will indicate the upstream component as their target, but this is not fundamentally required.

Packet transmission through the daisy chain topology may require that each component be capable of buffering any TLP it may receive (DLLP buffering is desirable, but not always possible because DLLPs do not have any flow control based limit on their number and frequency of transmission, and all DLLP protocols permit DLLPs to be discarded from time to time). When a TLP or DLLP is received that does not target the receiving component, that component transmits the TLP/DLLP, buffering it if necessary (for example because the component's transmitter is busy with a different transmission). When a packet passes through a component in this way, the component does not modify its internal state in any lasting way because of the packet (i.e., pass-through packet processing is strictly transient).

During the initial unique number assignment or through a subsequent discovery mechanism, the upstream component may capture information about the buffering resources available in each endpoint. This will allow the upstream component to direct the flow of TLPs through the daisy chain to avoid buffer overflow at any point. In case sufficient TLP buffering is not available, the receiving component may be permitted to discard one or more TLPs and rely on a TLP replay mechanism to cause the dropped TLPs to be resent by their original transmitter. When a TLP or DLLP is received that targets the receiving component, that component consumes the TLP/DLLP without transmitting it on to the next component. Accordingly, existing data integrity, flow control and addressing mechanisms may be extended to operate in the daisy-chain topology, such that embodiments may preserve maximum commonality with existing interface implementations while adding minimal cost.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
an upstream component including a plurality of virtual bridges to control communication with a corresponding plurality of endpoint components coupled downstream of the upstream component, the upstream component further including a shared port;
a first endpoint component of the plurality of endpoint components coupled to the upstream component via a first link; and
a final endpoint component of the plurality of endpoint components coupled to the preceding endpoint component via a second link and to the upstream component by a final link, wherein the upstream component and the plurality of endpoint components are coupled in a daisy chain topology and communicate according to a point-to-point (PTP) communication protocol.

2. The apparatus of claim 1, further comprising a second endpoint component of the plurality of endpoint components coupled to the first endpoint component via a third link and to the final endpoint component by the second link.

3. The apparatus of claim 1, wherein the upstream component and the plurality of endpoint components are each a semiconductor device, wherein the upstream component and the plurality of endpoint components are present on a single circuit board.

4. The apparatus of claim 1, wherein the upstream component comprises a root complex or a switch and further comprising at least one intermediate endpoint component coupled between the first endpoint component and the final endpoint component.

5. The apparatus of claim 4, wherein the first endpoint component is to pass a packet having an identifier field corresponding to the at least one intermediate endpoint component to the at least one intermediate endpoint component.

6. The apparatus of claim 1, wherein the upstream component is to transmit an assignment packet to the first endpoint component to assign a first identifier to the first endpoint component, the first endpoint is to modify the assignment packet and transmit the modified assignment packet to a next endpoint component to assign a second identifier to the next endpoint component.

7. The apparatus of claim 6, wherein the final endpoint is to receive the modified assignment packet from the next endpoint component and is to modify the modified assignment packet and transmit the second modified assignment packet to the upstream component, wherein the upstream component is to determine a number of endpoint components coupled in the daisy chain topology based on the second modified assignment packet.

8. The apparatus of claim 1, where each of the plurality of virtual bridges is associated with the shared port to manage communication with one of the first endpoint component and the final endpoint component.

9. A method comprising:
transmitting an assignment packet including a first identifier to a first endpoint component coupled to an upstream component in a daisy chain topology to assign the first identifier to the first endpoint component;
storing the first identifier associated with the first endpoint in the first endpoint component;
modifying the first identifier of the assignment packet in the first endpoint component to a second identifier; and
transmitting the modified assignment packet to a second endpoint component coupled to the first endpoint component to assign the second identifier to the second endpoint component.

10. The method of claim 9, further comprising:
storing the second identifier in the second endpoint component and modifying the modified assignment packet to a third identifier;
transmitting the second modified assignment packet to a third endpoint component coupled to the second endpoint component;
storing the third identifier in the third endpoint component and modifying the second modified assignment packet to a fourth identifier;
transmitting the third modified assignment packet to the upstream component; and
determining a number of endpoint components coupled in the daisy chain topology based on the third modified assignment packet.

11. The method of claim 10, further comprising determining buffer resources of the first, second and third endpoint components and directing flow of packets from the upstream component to the third endpoint component to avoid a buffer overflow in the first endpoint component or the second endpoint component.

12. The method of claim 9, further comprising receiving a packet having the second identifier in the first endpoint component, and passing the packet from the first endpoint component to the second endpoint component based at least in part on the second identifier.

13. The method of claim 12, further comprising buffering the packet in the first endpoint component before passing the packet.

14. The method of claim 10, further comprising dropping the packet in the first endpoint component and later passing a replayed packet to the second endpoint component, the replayed packet including data of the packet.

15. The method of claim 9, further comprising managing communications between the upstream component and the first endpoint component using a first virtual bridge of a plurality of virtual bridges of the upstream component, wherein the first virtual bridge is coupled to a shared port of the upstream component.
